(19) United States
(12) Patent Application Publication
(10) Pub. No.: US 2012/0173191 A1
(43) Pub. Date: Jul. 5, 2012

(54) Airspeed And Velocity Of Air Measurement

(76) Inventor: Lothar B. Moeller, Middletown, NJ (US)

(21) Appl. No.: 12/983,402

(22) Filed: Jan. 3, 2011

(51) Int. Cl. G01P 3/00; G06F 15/00

(52) U.S. Cl. 702/142; 73/488

(57) ABSTRACT

A velocity relevant to a body may be accurately measured using sound waves. Such velocity relevant to a body may be airspeed, i.e., the velocity of the body with respect to the surrounding air, or the velocity of air in the vicinity of the body or along its desired travel path. More specifically, the speed of two or more sounds may be correlated so that an airspeed, or the velocity of air, may be determined by taking into account the fact that sound traveling in the same direction as airflow travels faster than sound traveling in the direction opposite to airflow.

### TECHNICAL FIELD

This invention relates to measuring airspeed and the velocity of air.

### BACKGROUND OF THE INVENTION

It is well known to measure velocity of an object, e.g., an aircraft or other vehicle, with respect to the surrounding air. This velocity is known as airspeed. Note that because the air surrounding an object may be moving at different speeds and/or in different directions along the object, the airspeed of an object is really a local parameter for each of the object's surfaces.

Airspeed is typically measured using pitot tubes. Unfortunately, malfunctioning pitot tubes, which can occur if the tube gets jammed with foreign particles such as ice or insects, can lead to inaccurate airspeed readings. Such erroneous airspeed readings can mislead the piloting entity, whether human or automatic, into taking incorrect actions that result in a crash.

The impact of air on an object often affects the objects motion. Thus, it is often important to know the velocity of air at a particular location, e.g., in the vicinity of an object or along an expected path of an object.

### SUMMARY OF THE INVENTION

I have recognized that a velocity relevant to a body may be accurately measured, in accordance with the principles of the invention, by using sound waves. Such velocity relevant to a body may be airspeed, i.e., the velocity of the body with respect to the surrounding air, or the velocity of air in the vicinity of the body or along its desired travel path. More specifically, the speed of two or more sounds may be correlated so that an airspeed, or the velocity of air, may be determined by taking into account the fact that sound traveling in the same direction as airflow travels faster than sound traveling in the direction opposite to airflow.

In one embodiment of the invention, microphones placed at different locations on an aircraft body, typically located such that there is at least one forward and at least one aft of the engines, receive engine noise, which is then converted into digital form. Correlation between the received noise pattern is used to determine airspeed, which is then supplied for other use, e.g., to display the airspeed for a human being, such as the pilot, or to another device in the aircraft, e.g., an automatic pilot. In accordance with an aspect of the invention, speakers may be provided to supply an audio signal in the event of engine failure, so that even under such conditions airspeed may be determined. In accordance with another aspect of the invention, since the channel over which the engine noise or speaker sound may travel to the microphones may be nonlinear, time-variant, or exhibit multi-path distortion, advanced correlation algorithms may be performed to arrive at the correct airspeed.

In another embodiment of the invention, microphones are disposed, e.g., bilaterally, on a vehicle, such as a car or truck. Using a sound source, such as the car motor or preferably a speaker, which may be ultrasonic, the speed of the component perpendicular to the direction of travel of the vehicle of an air gust impacting on the vehicle may be measured. Under appropriate circumstances, control signals may be supplied to one or more of the car systems, such as the steering or suspension, to attempt to compensate for side winds and to improve safety and comfort.

In yet a further embodiment of the invention, the velocity of the wind in the vicinity of an aircraft, e.g., along the expected landing path of the aircraft, may be computed to better anticipate the effect of such wind on the aircraft so that proper controls may be applied to counter the expected force on the aircraft when it arrives in that area. More specifically, in such an embodiment of the invention, microphones positioned along a runway receive engine noise from an aircraft. The noise signals received by the microphones are supplied to a wind velocity determining unit, which may be remotely located from the microphones, and may even be on the aircraft. The noise signals supplied to the wind velocity determining unit may be supplied over one or more wired or wireless links.

The wind velocity determining unit correlates the received sounds and determines the speed of the wind at various locations along the expected path of the aircraft, e.g., it determines the wind shear the plane is facing at the current time. The velocity of the wind at each location includes a component parallel to the expected path of the aircraft, typically a runway, e.g., head or tail winds, and a component perpendicular to the expected path of the aircraft, typically a runway, that will confront the aircraft as it attempts to land, e.g., on the runway. Using such information, as well as possibly the altitude and/or attitude of the aircraft, an autopilot system may be employed to control the aircraft's motion, including possibly landing the aircraft under autopilot control. Such a system may be advantageously employed in poor weather conditions or on an aircraft carrier.

Advantageously, eliminating the use of pitot tubes avoids the problems that result when the pitot tubes malfunction.

### BRIEF DESCRIPTION OF THE DRAWING

In the drawing

FIG. 1 shows one embodiment of the invention in which microphones are placed at different locations on an aircraft body to receive engine noise which is then converted into digital form;

FIG. 2 shows a coordinate system defining a reference frame in which the air is defined as not moving for use in mathematically representing the positions of the engines and microphones such that the air speed of the aircraft of FIG. 1 or another object may be computed in accordance with the principles of the invention;

FIG. 3 shows another embodiment of the invention for determining the velocity of air impacting on an object, e.g., an automobile, in accordance with the principles of the invention;

FIG. 4 shows a further embodiment of the invention in which the velocity of the wind in the vicinity of an aircraft. e.g., along the expected landing path of the aircraft, may be computed; and

FIG. 5 shows an exemplary arrangement for determining airspeed, or the velocity of the wind in the vicinity of an object, in accordance with the principles of the invention.

### DETAILED DESCRIPTION

The following merely illustrates the principles of the invention. It will thus be appreciated that those skilled in the art will be able to devise various arrangements that, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

The functions of the various elements shown in the FIGs., including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementor as more specifically understood from the context.

In the claims hereof any element expressed as a means for performing a specified function is intended to encompass any way of performing that function. This may include, for example, a) a combination of electrical or mechanical elements which performs that function or b) software in any form, including, therefore, firmware, microcode or the like, combined with appropriate circuitry for executing that software to perform the function, as well as mechanical elements coupled to software controlled circuitry, if any. The invention as defined by such claims resides in the fact that the functionalities provided by the various recited means are combined and brought together in the manner which the claims call for. Applicant thus regards any means which can provide those functionalities as equivalent as those shown herein.

Software modules, or simply modules which are implied to be software, may be represented herein as any combination of flowchart elements or other elements indicating performance of process steps and/or textual description. Such modules may be executed by hardware that is expressly or implicitly shown.

Note that as used herein channel quality takes into account effects from channel properties, such as multipath and interference from other sources.

Unless otherwise explicitly specified herein, the drawings are not drawn to scale.

In the description, identically numbered components within different ones of the FIGs. refer to the same components.

A velocity relevant to a body may be accurately measured, in accordance with the principles of the invention, by using sound waves. Such velocity relevant to a body may be airspeed, i.e., the velocity of the body with respect to the surrounding air, or the velocity of air in the vicinity of the body or along its desired travel path. More specifically, the speed of two or more sounds may be correlated so that an airspeed, or the velocity of air, may be determined by taking into account the fact that sound traveling in the same direction as airflow travels faster than sound traveling in the direction opposite to airflow.

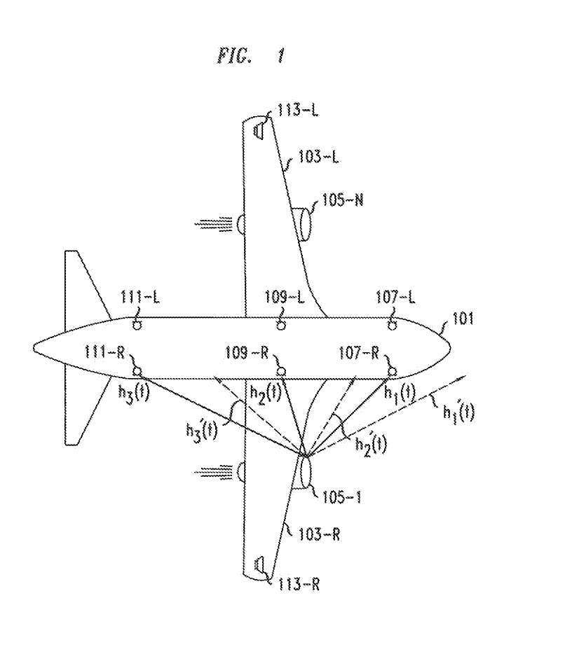

FIG. 1 shows one embodiment of the invention in which microphones are placed at different locations on an aircraft body, typically located such that there is at least one forward and at least one aft of the engines, to receive engine noise, which is then converted into digital form. Correlation between the noise patterns is used to determine airspeed, which is then supplied for other use, e.g., to display the airspeed for a human being, such as the pilot, or to another device in the aircraft, e.g., an automatic pilot.

More specifically, FIG. 1 shows aircraft 101, which includes wings 103-L and 103-R and engines 105, including engines 105-1 through 105-N, where N is typically in the range of 2-4. Note that although engines 105 are shown mounted on wings 103, they may be disposed elsewhere on aircraft 101, e.g., there may be one in the center back. Optional, exemplary speakers 113-R and 113-L are also shown disposed on aircraft 101, e.g., on wings 103-R and 103-L, respectively.

Also disposed on aircraft 101 are exemplary microphones 107-R, 107-L, 109-R, 109-L, 111-R and 111-L. The microphones on each side of aircraft 101 should preferably be positioned so that they are separated as far as possible. One or more of the various microphones may be directional microphones. The microphones may be mounted on the fuselage exterior or interior to the cabin, although for purposes of protecting the microphones, mounting them interior to the cabin is preferable. Also preferably, each of the microphones is directional and pointed to the sound source of interest for that microphone. Thus, for example, each of microphones 107-R, 109-R and 111-R would be pointed toward engine 105-1.

Typically during operation of aircraft 101 engines 105 generate tremendous sound signals. These signals are received and processed at various ones of the microphones, with the resulting electrical signals being digitized and processed to determine the airspeed of aircraft 101 in accordance with the principles of the invention. For the sake of clarity of exposition, only the right side of aircraft 101 and thus only those microphones with a -R suffix will be considered, but the same applies mutatis mutandis to the left side of aircraft 101 and those elements with -L suffix.

Using the well known principles of superposition, the velocity of sound from the engines can be considered to have two components, one parallel to the direction of the length of aircraft 101 and one perpendicular thereto. The component of interest for airspeed is the one along the direction of the length of aircraft 101.

Between engine 105-1 and each of microphones 107-R, 109-R, and 111-R there is formed a respective base channel for sound transmission. Between engine 105-1 and microphone 107-R the base channel is called h₁(t); between engine 105-1 and microphone 109-R the base channel is called h₂(t), and between engine 105-1 and microphone 111-R the base channel is called h₃(t). In actual practice the number of microphones is k, which should be at least 3. The microphones shown and disclosed herein are only exemplary and need not be the same on both sides of aircraft 101.

The base channel responses may be determined by measurement or simulating. Measuring the channel may be done using a model of aircraft 101, using speakers to simulate the noise from engines 105 and having microphones located at the scaled locations of microphones 107-R, 109-R, and 111-R. The model should be located sufficiently away from any surface to imitate being airborne. Alternatively, simulation may be done using the computer model used to fabricate aircraft 101, which has all the structural details of aircraft 101, and solving the wave equation, in a manner known to those of ordinary skill in the art.

Depending upon which reference frame is employed, the sound propagation may appear differently. Note that there are 2 reference frames which would be thought of initially, namely, 1) the reference frame based on aircraft 101, which is moving, and 2) the reference frame of the ground below aircraft 101, which is not moving. Furthermore, the actual channel over which the sound propagates while aircraft 101 is in motion is not the same as the base channel when aircraft 101 is still, mentioned above, and the channels during motion are velocity dependent.

Between engine 105-1 and microphone 107-R the operating channel is called h′₁(t); between engine 105-1 and microphone 109-R the operating channel is called h′₂(t), and between engine 105-1 and microphone 111-R the operating channel is called h′₃(t). Similar to the base channel responses, the operating channel responses may be determined by measurement or simulating. Measuring the channel may be done using a model of aircraft 101, using speakers to simulate the noise from engines 105. However, instead of having microphones located at the scaled locations of microphones 107-R, 109-R, and 111-R, the microphones need to be slid forward along a simulated flight path. This is because during operation, i.e., as the aircraft is moving, the location of the microphone that receives the sound will be further ahead along the path of motion than the location the microphone was at when the sound was generated. A table may be made by taking samples from the microphones at various distances from the initial position, to represent different speeds. Again, the model should be sufficiently away from any surface to imitate being airborne.

During operation, e.g., during flight, the signal S received at each of microphones 107-R, 109-R, and 111-R is the combination of the sound signal from engine 105-1 as affected by the particular channel over which it propagates over and noise from other sources, e.g., other engines such as engine 105-N, wind noise, and the like.

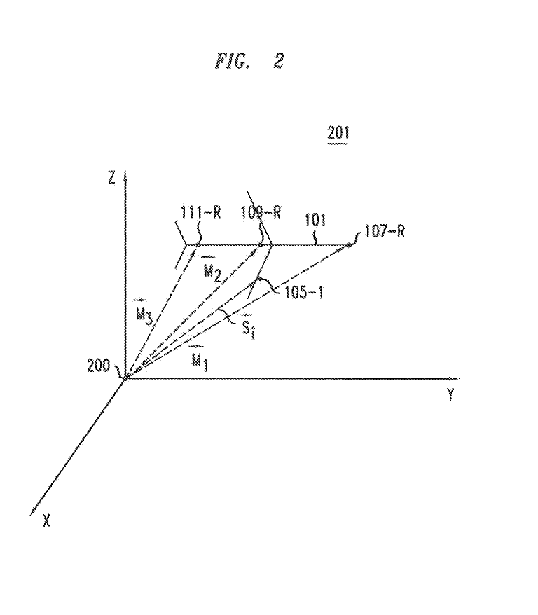

FIG. 2 shows coordinate system 201 defining a third reference frame, namely, the reference frame in which the air is defined as not moving, for use in mathematically representing the positions of the engines and microphones such that the air speed of aircraft 101 (FIG. 1), which is rendered in so-called “stick representation” in FIG. 2, or another object, may be computed in accordance with the principles of the invention. Note that each location in coordinate system 201 is represented as a vector from origin 200. It is not necessary to define where origin 200 is located since only differences between the location of the engine and the various microphones are needed for the calculations hereinbelow.

In coordinate system 201, for purpose of calculation, as explained hereinbelow, the location of engine 105-1 is designated \vec{S}ᵢ, where i can be used as an index to refer to different ones of the engines. Similarly, the position in the reference frame of microphone 107-R is designated as \vec{M}₁, the position in the reference frame of microphone 109-R is designated as \vec{M}₂, and the position in the reference frame of microphone 111-R is designated as \vec{M}₃. Conceptually, it may be considered that the aircraft is positioned such that the engine, e.g., engine 105-1, is located at the origin, i.e., \vec{S}ᵢ=(0, 0, 0).

The microphones should be located so that the respective vectors from each of engines 105 to each of the microphones on a particular side of the aircraft are not parallel. Note too, that when the aircraft is moving through the air, so that it is moving in the reference plane, the distance vector from the engine to each respective microphone remains constant but the velocity vector of the sound from the engine to each microphone is not the same as the distance vector from the engine to the microphone in the reference plane.

For ease of exposition and computation, each of the microphones is assigned a reference numeral from 1 to the maximum number of microphones on a side of aircraft 101. Thus, for example, microphone 107-R is designated microphone 1, receives signal n₁, and has its location in reference frame 201 specified by \vec{M}₁. Similarly, microphone 109-R is designated microphone 2, receives signal n₂, and has its location in the reference frame specified by \vec{M}₂. Likewise microphone 111-R is designated microphone 3, receives signal n₃, and has its location in reference frame 201 specified by \vec{M}₃.

The speed of the aircraft in the air, i.e., relative to the air around it, may be found as follows, in accordance with the principles of the invention. At time t₀, microphone 107-R is located at position \vec{M}₁, microphone 109-R is located at position \vec{M}₂, and engine 105 is at position \vec{S}ᵢ. The aircraft is moving with velocity \vec{v}ₚ in the reference plane, i.e., relative to the air. It is desired to determine the arrival time difference of the noise pattern between different pairs of microphone locations.

With the minimum number of three microphones, one should employ all the pairs of microphones. With more microphones it is preferable to employ all the pairs but a subset of pairs having no less than the pairs available for three microphones may be selected. Typically, the more microphones that are available and the more pairs that are used the more accurate the airspeed measurement will be, on average.

For example, for each particular pair of microphones, the arrival time difference may be determined by computing the maximum of the cross-correlation φₙ_{ₑ}ₙ_{ₗ}(τ) of the detected noise patterns between the various microphone pairs with a delay of τ. In other words, using e and l as variables used to refer to various ones of the microphones being employed for the calculation, the microphones being referred to as above, then for e=1 to the number of microphones employed and for l=1 to the number of microphones employed, e≠l, find the maximum of

φ_{n,n}_{₁}(τ)=nₑ(t+τ)n₁(τ) (1)

i.e., find

max{φₙ_{ₑ}ₙ_{ₗ}(τ)}=>τₘₐₓ

where

τₘₐₓ is the value of τ that yields the maximum of the cross correlation function, indicating the current delay for sound from the engine that is being detected by the two microphones;

nₗ(t) is the noise pattern picked up by microphone l, and the time variable t is continuous, so there is a noise pattern that is time dependent;

nₑ(t+τ) is the delayed or advanced noise pattern picked up by microphone e at time t+τ, where τ, which may be positive or negative, is the delay time between the time that the same pattern arrives at each of the microphone pairs, which theoretically ranges from minus infinity to plus infinity, but in practice is bounded from to 0 to the time it takes sound at its maximum velocity to travel the length of aircraft 101; and

[symbol] means to take the average over time, where the time window for the averaging could vary inversely with the bandwidth of the noise signal captured. For example, a window of a few milliseconds should be sufficient. This takes into account the integration which would otherwise have to be specified for the correlation.

In other words, conceptually, τₘₐₓ (e, l)=tₑ−tₗ, where tₑ is the arrival time of the signal from the engine at microphone e and tₗ is the arrival time of the signal from the engine at microphone l.

Note of course that the foregoing assumes that the digitization of the signal at each microphone to develop the representation of the noise signal that is used for processing as described herein is essentially identical for each microphone, especially in regard to the delay introduced by the digitization path. Otherwise the delay difference in the digitization must be accounted for.

For each microphone e, where e, as above, ranges from 1 to the number of microphones, we formulate the equation

|\vec{M}ₑ−\vec{S}ᵢ+(tₑ−t₀)\vec{v}ₚ|=|\vec{c}ₛ|(tₑ−t₀) (2)

where

tₑ=τₘₐₓ(e,l)+tₗ;

\vec{M}ₑ is the vector from the origin in the reference frame to the location of microphone e at t₀, where t₀ is the time when the noise received at microphone e was generated;

\vec{v}ₚ is the velocity of the aircraft relative to the air, i.e., the airspeed in reference frame 201 along the fuselage, the absolute value of which is the variable which we seek;

\vec{S}ᵢ is the vector from the origin in the reference frame to the location of the noise source, e.g., engine 105-R or optional speaker 113-R;

\vec{c}ₛ is the velocity of sound in the reference frame, which is unknown, as it is based on various factors such as air pressure, temperature, humidity, etc., but will ultimately not be needed to be known in order to determine the air speed, since its value can be expressed in terms of other factors in the equations, and when appropriate substitutions are made, the value of \vec{c}ₛ is eliminated;

tₑ−t₀ is the time that it takes the sound to travel from the sound source to microphone e, so that |\vec{c}ₛ|(tₑ−t₀) is the distance that the sound actually travels during the interval tₑ−t₀.

Note that when l changes, τₘₐₓ (e, l) changes, so the value of tₑ stays the same. Also note that, as mentioned hereinabove, only the difference \vec{M}ₑ−\vec{S}ᵢ is required, so it is not necessary to know the precise location of the origin of the reference frame.

In order to find \vec{v}_{μ}, a solution is found for the set of simultaneous equations represented by eq. (2). Any method for determining the solution may be employed. For example, one may search for numerical solutions to the simultaneous equations, e.g., to using the techniques of the FindRoot command of Mathematica® 8, which is commercially available from Wolfram Research, http://www.wolfram.com/. Alternatively, one might employ one of the various techniques disclosed in A New Approach for Solving Nonlinear Equations Systems by Crina Grosan and Ajith Abraham which is published in IEEE Transactions On Systems, Man, And Cybernetics—Part A: Systems And Humans, Vol. 38, NO. 3, May 2008 pp. 698-714.

The channel between the engine and each of the microphones suffers from various channel effects, such as differences in temperature along the channel and reflections from the fuselage. Low frequency sounds tend to propagate in a more omnidirectional manner, while higher frequency sounds tend to propagate in a more focused manner, especially taking into account an aperture through which the sound may pass. Jet engines typically generate sounds at many frequencies, low and high, and these sounds are radiated in a pattern that is a function of the frequencies and the structure of the engine. Because the engine sound radiation characteristic dominates the other channel effects, which are of a higher order, the sound patterns that arrive at each microphone, while very similar, are not necessarily exactly the same except for their delay in time, even after taking into account such channel effects.

Therefore, it is desirable to compensate for such engine sound radiation characteristics in order to provide for a more precise finding of each delay maximum, in accordance with an aspect of the inventions. In accordance with an aspect of the invention this can be achieved by finding the inverse channel function of the channel from the sound source to the microphone.

The inverse channel function can be represented as

nₑ(t)=hₑ(|\vec{v}ₚ|)*sₙ(t)

where

sₙ(t) is the noise generated by the sound source;

hₑ(|\vec{v}ₚ|,t) is the channel transfer function for microphone e at time t, where e can range from 1 to the number of microphones;

* is convolution; and

nₑ(t) is the noise pattern that is used for the analysis in equation 1.

Note that the channel transfer function depends weakly on \vec{v}ₚ, the velocity of the aircraft relative to the air, i.e., the airspeed in reference frame 201, which is the variable which we ultimately seek.

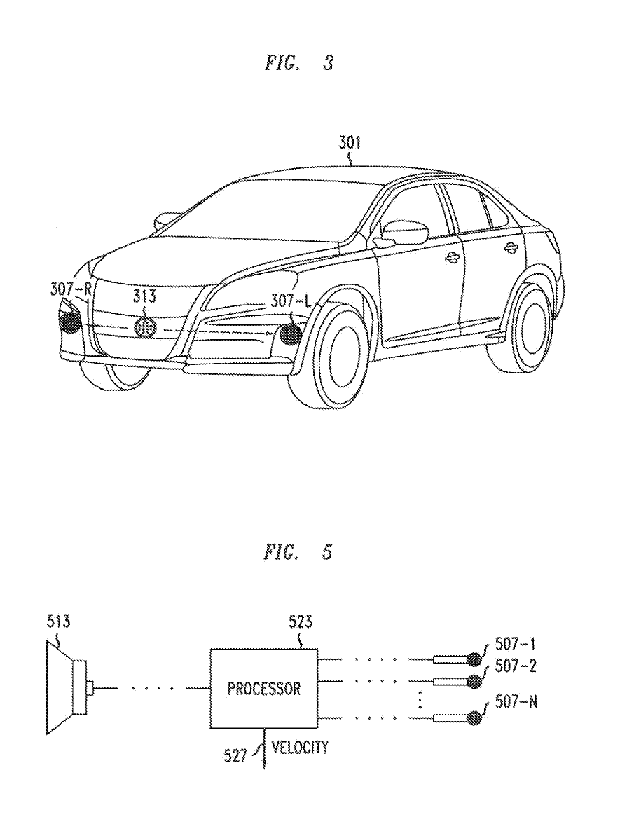

FIG. 3 shows another embodiment of the invention, in which microphones 307-R and 307-L are disposed, e.g., bilaterally, on vehicle 301, such as a car or truck. It is desirable that the microphones be located along the front face of vehicle 301, preferably as close to each side edge as possible, in the manner shown. Using a sound source, such as the vehicle motor (not visible because it is inside vehicle 301, e.g., under the hood,) or, preferably, speaker 313, which may be ultrasonic, the speed of the component perpendicular to the direction of travel of the vehicle of an air gust impacting on the vehicle, i.e., a side wind, may be measured, and tinder appropriate circumstances, control signals may be supplied to one or more of the car systems, such as the steering or suspension, to attempt to compensate for such side wind and to improve safety and comfort.

The reference frame employed for determining the gust impacting on the vehicle is as before, namely, the reference frame in which the air is defined as not moving. So, conceptually the origin is sitting on a molecule of the gust. Similar to the airspeed case above, for purpose of calculation, as explained hereinbelow, the location of speaker 313 is designated \vec{S}_{S}. Also, similarly, the position in the reference frame of microphone 307-R is designated as \vec{M}_{R}, and the position in the reference frame of microphone 307-L is designated as \vec{M}_{L}. Conceptually, it may be considered that the vehicle is positioned such that speaker 313 is located at the origin if the reference frame, i.e., \vec{S}ₛ=(0, 0, 0).

The speed of the component perpendicular to the direction of travel of the vehicle of an air gust impacting on the vehicle, may be found as follows, in accordance with the principles of the invention. At time t₀, microphone 307-R is located at position \vec{M}_{R}, microphone 307-L is located at position \vec{M}_{L} and speaker 313 is at position \vec{S}_{S}. The vehicle surroundings are moving with velocity \vec{v}ₚ in the reference plane. It is desired to determine the arrival time difference of the noise pattern between the pairs of microphone locations. For the pair of microphones 307, the arrival time difference may be determined by computing the maximum of the cross-correlation φₙ_{_{L}}ₙ_{_{R}}(τ) of the detected noise patterns between the microphones with a delay of τ. In other words, find the maximum of

φₙ_{_{L}}ₙ_{_{R}}(τ)=n_{L}(t+τ)n_{R}(τ),

i.e., find

max{φₙ_{_{L}}ₙ_{_{R}}(τ)}=>τₘₐₓ

where

τₘₐₓ is the value of τ that yields the maximum of the cross correlation function, indicating the current delay for sound from the engine that is being detected by the two microphones;

n_{L}(f) is the noise pattern picked up by microphone 307-L, and the time variable t is continuous, so there is a noise pattern that is time dependent;

n_{R}(t+τ) is the delayed or advanced noise pattern picked up by microphone 307-R at time t+τ, where τ, which may be positive or negative, is the delay time between the time that the same pattern arrives at each of the microphone pairs, which theoretically ranges from minus infinity to plus infinity, but in practice is bounded from to 0 to the time it takes sound at its maximum velocity to travel the width of vehicle 301 divided by the velocity of sound; and

[symbol] means to take the average over time, where the time window for the averaging could vary inversely with the bandwidth of the noise signal captured. For example, a window of a few milliseconds should be sufficient. This takes into account the integration which would otherwise have to be specified for the correlation.

In other words, conceptually, τₘₐₓ (L, R)=t_{L}−t_{R}, where t_{L} is the arrival time of the signal from speaker 313 at microphone 307-L and t_{R} is the arrival time of the signal from the speaker 313 at microphone 307-L.

Note, of course, that the foregoing assumes that the digitization of the signal at each microphone to develop the representation of the noise signal that is used for processing as described herein is essentially identical for each microphone, especially in regard to the delay introduced by the digitization path. Otherwise the delay difference in the digitization must be accounted for.

Formulating the following equations

|\vec{M}_{L}−\vec{S}ₛ+(t_{L}−t₀)(\vec{v}ₚ+\vec{v}_{V})|=|\vec{c}ₛ|(t_{L}−t₀) (3)

|\vec{M}_{R}−\vec{S}ₛ+(t_{R}−t₀)(\vec{v}ₚ+\vec{v}_{V})|=|\vec{c}ₛ|(t_{R}−t₀) (4)

where

t_{L}=τₘₐₓ(L,R)+t_{R};

\vec{M}_{L} is the vector from the origin in the reference frame to the location of microphone 307-L at t₀, where t₀ is the time when the noise received at microphone 307-L was generated;

\vec{M}_{R} is the vector from the origin in the reference frame to the location of microphone 307-R at t₀, where t₀ is the time when the noise received at microphone 307-R was generated;

\vec{v}ₚ is the velocity of the air gust impacting on the vehicle with respect to the ground;

\vec{S}ₛ is the velocity of the vehicle with respect to the ground; is the vector from the origin in the reference frame to the location of the noise source, e.g., speaker 313;

|\vec{c}ₛ| is the speed of sound in air, which, for purposes of determining the side wind, it is assumed that the conventionally accepted speed of sound through air of 340 meters per second is generally sufficiently precise to accommodate terrestrial altitudes and typical weather conditions, although adjustments for actual altitude and weather conditions may be made if further precision is desired;

t_{L}−t₀ is the time that it takes the sound to travel from the sound source to microphone 307-L, so that |\vec{c}ₛ|(t_{L}−t₀) is the distance that the sound actually travels during the interval t_{L}−t₀; and

t_{R}−t₀ is the time that it takes the sound to travel from the sound source to microphone 307-R, so that |\vec{c}ₛ|(t_{R}−t₀) is the distance that the sound actually travels during the interval t_{R}−t0 in the reference frame.

In order to find \vec{v}ₚ, a solution is found for the set of simultaneous equations represented by equations (3) and (4). Any method for determining the solution may be employed. For example, one may search for numerical solutions to the simultaneous equations, e.g., using the techniques of the FindRoot command of Mathematica® 8, which is commercially available from Wolfram Research, http://www.wolfram.com/. Alternatively, one might employ one of the various techniques disclosed in A New Approach for Solving Nonlinear Equations Systems by Crina Grosan and Ajith Abraham which is published in IEEE Transactions On Systems, Man, And Cybernetics—Part A: Systems And Humans, Vol. 38, NO. 3, May 2008 pp. 698-714.

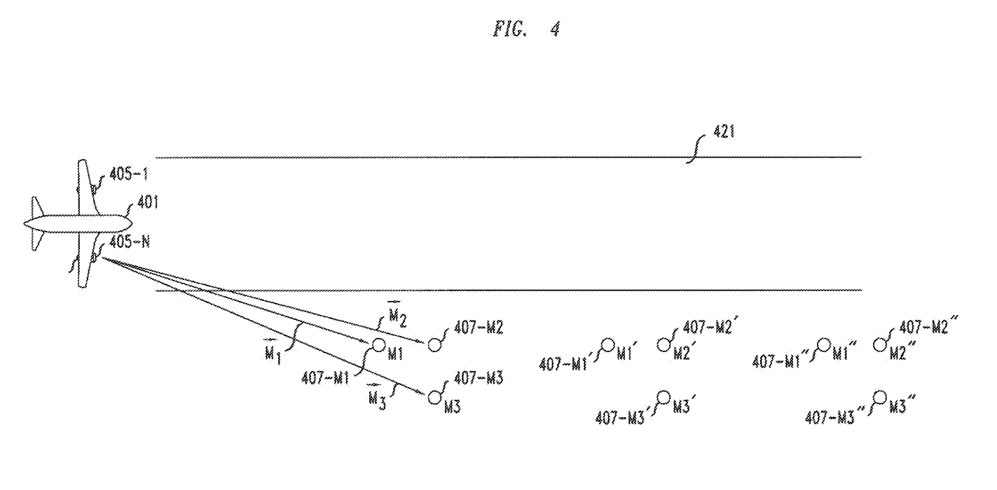

In yet a further embodiment of the invention, shown in FIG. 4, the velocity of the wind in the vicinity of an aircraft, e.g., along the expected landing path of the aircraft, may be computed to better anticipate the effect of such wind on the aircraft so that proper controls may be applied to counter the expected force on the aircraft when it arrives in that area. More specifically, FIG. 4 shows groups of microphones, including at leak microphone groups 407, 409, and 411 which are positioned along runway 421 to receive noise from aircraft 401, e.g., noise from engines 405 or noise from a speaker mounted on aircraft 401 (not shown). Typically, each microphone group consists of three microphones, the microphones being arranged such that the location of two of them form a line segment that is parallel to runway 421 and the location of the third microphone is such that a line segment from it to one of the other two microphones is perpendicular to runway 421. See for example microphone group 407, which includes microphones 407-M1, 407-M2, and 407-M3. Connecting the locations of microphones 407-M1 and 407-M2 forms a line segment parallel to runway 421 and connecting the locations of microphones 407-M2 and 407-M3 forms a line segment perpendicular to runway 421. The microphones of microphone group 409, which includes microphones 409-M1′, 409-M2′, and 409-M3′ and microphone group 411, which includes microphones 411-M1″, 411-M2″, and 411-M3″ are similarly arranged, in the manner shown in FIG. 4.

The noise signals received by the microphones are supplied to a wind velocity determining unit, which may be remotely located from the microphones, and may even be on aircraft 401. The noise signals supplied to the wind velocity determining unit may be supplied over one or more wired or wireless links. The wind velocity determining unit correlates the received sounds and determines the velocity of the wind at various locations along the expected path of the aircraft, e.g., it determines the wind shear the plane is facing at the current time. The wind at each location includes a component parallel to the expected path of the aircraft, typically a runway, e.g., head or tail winds, and a component perpendicular to the expected path of the aircraft, typically a runway, e.g., a side wind. These winds will confront the aircraft as it proceeds along its path, such as attempting to land, e.g., on runway 421.

The wind velocity determining unit operates as follows. It is assumed that aircraft 401 is far enough away from the particular microphone groups of interest, e.g., microphone groups 407, 409, and 411, so that the sound propagating from aircraft 401 can be treated as a plane wave, i.e., treated using the approximation assuming that the phase front of the sound wave is more or less flat. Note that this approximation is more accurate when the spacing between the microphones within a group is relatively small.

The reference plane is such that the microphones and runway 421 are not moving. \vec{M}₁ is the distance in the reference plane from aircraft 401 to microphone 407-M1, \vec{M}₂ is the distance in the reference plane from aircraft 401 to microphone 407-M2, and \vec{M}₃ is the distance in the reference plane from aircraft 401 to microphone 407-M3. The vectors \vec{M}₁, \vec{M}₂, and \vec{M}₃ need not be actually determined. This is because only the specified differences are relevant to the calculations and these differences may be determined by measuring the spacing among the microphones.

The wind velocity component parallel to runway 421 at approximately the location of group of microphones 407 along runway 421 is determined using microphones 407-M1 and 407-M2. The arrival time difference of a sound pattern from aircraft 401 at microphones 407-M1 and 407-M2, is determined by computing the maximum of the cross-correlation φ_{M}_{₁}_{M}_{₂}(τ) of the detected noise patterns between the microphones 407-M1 and 407-M2 with a delay of τ. In other words, find the maximum of

φ_{M}_{₁}_{M}_{₂}(τ)=M₁(t+τ)M₂(τ) (3),

i.e., find

max{φ_{M}_{₁}_{M}_{₂}(τ)}=>τ₁₂

where

[symbol] means to take the average over time, where the time window for the averaging could vary inversely with the bandwidth of the noise signal captured. For example, a window of a few milliseconds should be sufficient. This takes into account the integration which would otherwise have to be specified for the correlation. Note that, τ₁₂ is the value of τ that yields the maximum of the cross correlation function, indicating the current delay for sound from the engine that is being detected by the two'microphones 407-M1 and 407-M2.

Thereafter, the parallel component of the wind velocity, v^{para}, is determined by computing cₛ=|\vec{M}₁−\vec{M}₂|/τ₁₂=v^{para}, where c, represents the velocity of sound. For this particular application, the velocity of sound near to the runway is of interest, cₛ is generally well approximated by the value 340 m/s.

The wind velocity component perpendicular to runway 421 at approximately the location of group of microphones 407 along runway 421 is determined using microphones 407-M2 and 407-M3. The arrival time difference of a sound pattern from aircraft 401 at microphones 407-M2 and 407-M3, is determined by computing the maximum of the cross-correlation φ_{M}_{₂}_{M}_{₃}(τ) of the detected noise patterns between the microphones 407-M2 and 407-M2 with a delay of τ. In other words, find the maximum of

φ_{M}_{₂}_{M}_{₃}(τ)=M₂(t+τ)M₃(τ),

i.e., find

max{φ_{M}_{₂}_{M}_{₁}(τ)}=>τ₂₃

where

[symbol] means to take the average over time, where the time window for the averaging could vary inversely with the bandwidth of the noise signal captured. For example, a window of a few milliseconds should be sufficient. This takes into account the integration which would otherwise have to be specified for the correlation. Note that, τ₂₃ is the value of τ that yields the maximum of the cross correlation function, indicating the current delay for sound from the engine that is being detected by the two microphones 407-M1 and 407-M2.

Thereafter, the perpendicular component of the wind velocity, v^{perp}, is determined by computing cₛ=|\vec{M}₂−\vec{M}₃|/τ₂₃=v^{perp}.

Note, of course, as previously mentioned, the foregoing assumes that the digitization of the signal at each microphone to develop the representation of the noise signal that is used for processing as described herein is essentially identical for each microphone, especially in regard to the delay introduced by the digitization path. Otherwise the delay difference in the digitization must be accounted for.

Some or all of the microphones may be directional, in that they are designed to focus their reception of sound on direction from where the aircraft is coming, e.g., in opposite direction of the respective one of vectors \vec{M}₁, \vec{M}₂, and \vec{M}₃ that is associated with the particular microphone.

Other groups of microphones disposed at different positions along the runway, e.g., groups of microphones 409 and 411 can be used to determine the wind components at their respective locations using the same techniques, substituting the use of the particular microphone in the group for the like-located microphone in group of microphones 407 in performing the calculations. Thus, the wind velocity along the aircraft's expected path, e.g., down runway 421 may be determined.

The wind information may be displayed for perception by a human, e.g., a pilot. Also, using such information, as well as possibly the altitude and/or attitude of the aircraft, an autopilot system may be employed to control the aircraft's motion, including possibly landing the aircraft under autopilot control. Such a system may be advantageously employed in poor weather conditions or on an aircraft carrier to assist with landing the aircraft.

FIG. 5 shows an exemplary arrangement for determining airspeed, or the speed of the wind in the vicinity of an object, e.g., a vehicle, in accordance with the principles of the invention. Shown in FIG. 5 is processor 523, microphones 507, including microphones 507-1 through 507-N, and speaker 513. Microphones 507 are representative of any of the microphones employed in embodiments of the invention shown and described in connection with FIGS. 1-4. Microphones 507 may also be considered to include any circuitry for digitizing the sound received thereat. Similarly, speaker 513 is representative of any of the speakers employed in embodiments of the invention shown and described in connection with FIGS. 1-4.

Links 519 couple microphones 507 to processor 523. Links 519 may be any type, e.g., wired, wireless, optical, or any combination thereof and the signals carried by links 519 may be analog or digital or any combination thereof. As noted, digitization of the sound signal detected by microphones 507 may be performed either at microphone 507, or it may be performed as part of links 519, at processor 523, or a combination thereof.

Processor 523, when appropriately programmed, performs the operations and calculations employed in embodiments of the invention shown and described in connection with FIGS. 1-4. The determined velocity may be supplied as an output on link 527. As indicated hereinabove, the velocity may be supplied to a display, so that a visual representation may be observed by a human, e.g., a driver or pilot, or the velocity maybe supplied to an automatic pilot, for use in controlling a vehicle to which the velocity is relevant.

Although the foregoing description is in terms of air, one of ordinary skill in the art will readily be able to adapt the principles of the invention to other gases, or other medium through which sound and a body may travel, e.g., liquids generally, and of particular interest water and water based solutions.

What is claimed is:

1. Apparatus, comprising:
a plurality of sound detectors, each of said sound detectors being adapted to receive sound signals from at least one sound source; and
a processor, coupled to said sound detectors, for determining a velocity relevant to a body.

2. The invention as defined in claim 1 wherein said sound source is disposed on said body.

3. The invention as defined in claim 1 wherein at least one of said sound detectors is disposed on said body.

4. The invention as defined in claim 1 wherein at least one of said sound detectors is located off of said body.

5. The invention as defined in claim 1 wherein said velocity relevant to said body is determined by comparing a time for detecting a sound from said sound source at a first of said sound detectors with the a time for detecting said sound from said sound source at at least a second of said sound detectors.

6. The invention as defined in claim 1 further comprising at least a second sound source disposed on said body.

7. The invention as defined in claim 6 wherein said second sound source is employed to determine said velocity when said first sound source is silent.

8. The invention as defined in claim 1 wherein said velocity is determined as a function of a difference in time for detecting a sound from said sound source at a first of said sound detectors and detecting said sound at least a second of said sound detectors.

9. The invention as defined in claim 1 wherein at least a first of said sound detectors is located forward of said sound source on said body and at least a second of said sound detectors is located aft of said sound source on said body.

10. The invention as defined in claim 1 wherein at least two of said sound detectors are bilaterally disposed on said body.

11. The invention as defined in claim 1 wherein said at least one sound source is an engine.

12. The invention as defined in claim 1 wherein said sound detectors are coupled to said processor wirelessly.

13. The invention as defined in claim 1 wherein said sound detectors are coupled to said processor via a non-wireless connection.

14. The invention as defined in claim 1 wherein said velocity relevant to said body is an airspeed of said body.

15. The invention as defined in claim 1 wherein said processor determines a maximum cross-correlation of detected sound signal patterns between a first of said sound detectors and each of a second and third of said sound detectors, said second sound detector being located on said body forward of said first sound detector and said third sound detector being located on said body aft of said first sound detector.

16. The invention as defined in claim 1 wherein said processor determines for e=1 to a number of said sound detectors and for l=1 to said number of sound detectors, e≈l, the maximum of
φₙ_{ₑ}ₙ_{₁}(τ)=nₑ(t+τ)n₁(τ),
where
nₗ(t) is a time dependent sound signal pattern from said sound source detected by sound detector l;
nₑ(t+τ) is a time offset sound signal pattern from said sound source detected by sound detector e at time t+τ, where τ, which may be positive or negative, and [symbol]
indicates averaging over time.

17. The invention as defined in claim 16 wherein said processor determines said velocity relevant to said body, \vec{v}ₚ, by solving a set of simultaneous equations representable as |\vec{M}ₑ−\vec{S}ᵢ+(tₑ−t₀)\vec{v}ₚ|=|\vec{c}ₛ|(tₑ−t₀), where e ranges from 1 to the number of sound detectors and represents a particular sound detector, where
tₑ=τₘₐₓ (e, l)+tₗ, τₘₐₓ being max{φₙ_{ₑ}ₙ_{ₗ}(τ)}=>τₘₐₓ(e,l) and so indicating a value of τ that yields a maximum of the cross correlation function thereby indicating a current delay for sound from said sound source as detected by sound detectors e and l,
\vec{M}ₑ is a vector from an origin of a reference frame in which air around said body is not moving to the location of sound detector e at t₀, where t₀ is a time when a sound signal generated at said sound source is received at sound detector e was generated;
\vec{v}ₚ is a velocity of said body relative to said surrounding air;
\vec{S}ᵢ is a vector from said origin to a current location of said sound source;
\vec{c}ₛ is a velocity of sound in said reference frame; and
tₑ−t₀ is a time for sound to travel from said sound source to sound detector e.

18. The invention as defined in claim 1 wherein said at least one sound source is a speaker.

19. The invention as defined in claim 1 wherein said at least one sound source is a source of ultrasonic sound.

20. The invention as defined in claim 1 wherein said velocity relevant to said body is a component of a velocity of air impacting on said body.

21. The invention as defined in claim 1 wherein said velocity relevant to said body is a component of a velocity of an air gust impacting on said body perpendicular to a direction of travel of said body.

22. The invention as defined in claim 1 wherein said processor determines a maximum cross-correlation of detected sound signal patterns between a first and a second of said sound detectors, said first and second sound detectors being located on said body such that said sound source is located therebetween.

23. The invention as defined in claim 1 wherein said processor determines a maximum of
φₙ_{_{L}}ₙ_{_{R}}(τ)=n_{1.}(t+τ)n_{R}(τ),
where
n_{L}(t) is a sound signal pattern from said sound source detected by a one of said sound detectors located left of said sound source and time variable t is continuous;
n_{R}(t+τ) is a time offset version of said sound signal pattern detected by a one of said sound detectors located right of said sound generator at time t+τ, where τ, which may be positive or negative, is the delay time between the time that the same pattern arrives at each of the microphone pairs; and [symbol]
indicates averaging over time.

24. The invention as defined in claim 30 wherein said processor determines said velocity relevant to said body, \vec{v}ₚ, by solving a set of simultaneous equations representable as

|\vec{M}_{L}−\vec{S}ₛ+(t_{L}−t₀)(\vec{v}ₚ+\vec{v}_{V})|=|\vec{c}ₛ|(t_{L}=t₀)

|\vec{M}_{R}−\vec{S}ₛ+(t_{R}−t₀)(\vec{v}ₚ+\vec{v}_{V})|=|\vec{c}ₛ|(t_{R}=t₀)
where
t_{L}τₘₐₓ (L, R)+t_{R}, where max{φₙ_{_{L}}ₙ_{_{R}}(τ)}=>τₘₐₓ and so indicates a value of τ that yields a maximum of the cross correlation function thereby indicating a current delay for sound from said sound source as detected by sound detectors L and R;
\vec{M}_{L} to is a vector from an origin of a reference frame in which air around said body is not moving to the location of said one of said sound detectors located left of said sound generator at t₀, where t₀ is a time when said sound signal detected at said left located sound detector was generated at said sound source;
\vec{M}_{L} is a vector from an origin of said reference to a location of said one of said sound detectors located right of said sound generator at to;
\vec{v}ₚ is a velocity of an air gust impacting on said body;
\vec{v}_{V} is a velocity of said body with respect to the ground;
\vec{S}ᵢ is a vector from said origin of said reference frame to a location of said sound source;

|\vec{c}ₛ| is a speed of sound in air;
t_{L}−t₀ is a time for sound to travel from said sound source to said one of said sound detectors located left of said sound source; and
t_{R}−t₀ is a time for sound to travel from said sound source to said one of said sound detectors located right of said sound source.

25. The invention as defined in claim 1 wherein said velocity relevant to said body is a component of a velocity of air along an anticipated path of movement of said body.

26. The invention as defined in claim 1 wherein said velocity relevant to said body is a component of a velocity of air parallel to a desired path of movement of said body.

27. The invention as defined in claim 1 wherein said processor determines a maximum of
φ_{M}_{₁}_{M}_{₂}(τ)=M₁(t+τ)M₂(τ),
where
M₂(t) is a sound signal pattern from said sound source detected by a one of said sound detectors M₂ located along a line parallel to a desired direction of travel of said body and time variable t is continuous;
M₁(t+τ) is a time offset version of said sound signal pattern from said sound generator detected by a one of said sound detectors M₁ located along said line at time t+τ, where τ, which may be positive or negative, is a delay time between the time that said to sound signal pattern arrives at each of said sound detectors M₁ and M₂; [symbol]
indicates averaging over time.

28. The invention as defined in claim 27 wherein said processor determines said velocity relevant to said body v^{para} by computing cₛ−|\vec{M}₁−\vec{M}₂|/τ₁₂=v^{para}
where
cₛ is a velocity of sound;
v^{para} is a component of wind velocity parallel to said desired path of travel of said body;
max{φ_{M}_{₁}_{M}_{₂}(τ)}=>τ₁₂ is the value of τ that yields the maximum of the cross correlation function, indicating the current delay for a sound that is being detected by said sound detectors M₁ and M₂;
\vec{M}₁ is the distance from said body to said sound detector M₁ in a reference plane in which said sound detector M₁ is not moving; and
\vec{M}₂ is the distance from said body to said sound detector M₂ in said reference plane.

29. The invention as defined in claim 1 wherein said velocity relevant to said body is a component of a velocity of air perpendicular to a desired path of movement of said body.

30. The invention as defined in claim 1 wherein said processor determines a maximum of
φ_{M}_{₂}_{M}_{₃}(τ)=M₂(t+τ)M₃(τ),
where
M₃(t) is a sound signal pattern from said sound source detected by a one of said sound detectors M₃ located along a line perpendicular to a desired direction of travel of said body and time variable t is continuous;
M₂(t+τ) is a time offset version of said sound signal pattern from said sound generator detected by a one of said sound detectors M₂ located along said line at time t+τ, where τ, which may be positive or negative, is a delay time between the time that said to sound signal pattern arrives at each of said sound detectors M₂ and M₃; and [symbol]
indicates averaging over time.

31. The invention as defined in claim 30 wherein said processor determines said velocity relevant to said body v^{perp} by computing cₛ−|\vec{M}₂−\vec{M}₃|/τ₂₃=v^{perp}
where
cₛ is a velocity of sound;
v^{perp} is a component of wind velocity perpendicular to said desired path of travel of said body;
max{φ_{M}_{₂}_{M}_{₂}(τ)}=>τ₂₃ is the value of τ that yields the maximum of the cross correlation function, indicating the current delay for a sound that is being detected by said sound detectors M₂ and M₃;
\vec{M}₂ is the distance from said body to sound detector M₂ in a reference plane in which said sound detector M₂ is not moving; and
\vec{M}₃ is the distance from said body to sound detector M₃ in said reference plane.

32. The invention as defined in claim 1 wherein at least one of said sound detectors is a microphone.

33. The invention as defined in claim 1 wherein at least one of said sound detectors is a directional microphone.

34. The invention as defined in claim 1 wherein each of said sound detectors has a same delay in providing a detected sound to said processor.

35. The invention as defined in claim 1 wherein said airspeed is determined by comparing a time for detecting a sound from a first of said at least one sound sources at a first of said sound detectors with the a time for detecting said sound at a second of said sound detectors.

36. Apparatus comprising:
at least one sound source disposed on a body;
a plurality of microphones for receiving said sound; and
means for determining a velocity relevant to said body.

37. A method comprising the steps of
receiving a sound signal from a sound source using at least two sound detectors located separately from each other; and
determining a velocity relevant to a body by performing at least one correlation operation between a version of said signal as received at each of said at least two sound detectors.

38. The invention as defined in claim 37 further comprising the step of transmitting said sound signal.

39. Apparatus comprising:
at least one sound source disposed on a body;
a plurality of microphones for receiving said sound, at least one of said microphones being located independent of said body; and
means for determining a velocity relevant to said body.

40. Apparatus, comprising:
a plurality of sound detectors, each of said sound detectors being adapted to receive sound signals from at least one sound source coupled to a body; and
a correlator, coupled to said sound detectors, for determining an airspeed of said body.

41. Apparatus, comprising:
a plurality of sound detectors, each of said sound detectors being adapted to receive sound signals from at least one sound source coupled to a body; and
a correlator, coupled to said sound detectors, for determining a velocity of air along a desired travel path of said body.

42. The invention as defined in claim 41 wherein at least one of said sound detectors is coupled to said body.

43. The invention as defined in claim 41 at least one of said sound detectors is located at a location independent of a location of said body.
